(19) United States
(12) Patent Application Publication
(10) Pub. No.: US 2008/0247190 A1
(43) Pub. Date: Oct. 9, 2008

(54) HIGH BRIGHTNESS DIFFUSION PLATE

(75) Inventors: Tzeng-Ke Shiau, Hsinchu (TW); Lung-Shiang Luh, Hsinchu (TW); Ming-Dah Liu, Hsinchu (TW); Der-Woei Hsaio, Hsinchu (TW); Shin-Ping Kung, Hsinchu (TW); Bih-Chang Wang, Hsinchu (TW); Huan-Tsung Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/834,022

(22) Filed: Aug. 6, 2007

(30) Foreign Application Priority Data
Apr. 4, 2007 (TW) 96112001

(51) Int. Cl. G02B 5/02

(52) U.S. Cl. 362/608

(57) ABSTRACT

A high brightness diffusion plate for homogenizing light beams provided by at least one light source of a backlight module to a display panel is provided, which includes a diffusion layer, a transmittance layer, and a plurality of connecters. The transmittance layer is disposed above the diffusion layer, and the connecters are connected between the diffusion layer and the transmittance layer. Since the high brightness diffusion plate of the present invention is an integrated structure and is stronger, the present invention is not only easier for being assembled inside the backlight module, but also makes the light source provided by the backlight module being more homogeneous.

### CROSS-REFERENCE TO RELATED APPLICATION

This application claims the priority benefit of Taiwan application serial no. 96112001, filed Apr. 4, 2007. All disclosure of the Taiwan application is incorporated herein by reference.

### BACKGROUND OF THE INVENTION

1. Field of the Invention

The present invention relates to a diffusion plate, and particularly, to a high brightness diffusion plate.

2. Description of Related Art

With the development of science and technology, a thin film transistor liquid crystal display (TFT LCD) having advantages of high definition, effective space utilization, low power consumption and no radiation has gradually substituted the cathode ray tube (CRT) display to become the mainstream of the market. As for the TFT LCD, since the liquid crystal panel does not emit light beams, a backlight module is disposed below the liquid crystal panel for providing light beams, so as to enable the TFT LCD to have a display function.

Referring to FIG. 1, a conventional backlight module 100 includes a lamp housing 110, a plurality of cold cathode fluorescence lamps (CCFL) 120 and a diffusion plate 130. The CCFLs 120 are arranged in parallel in the lamp housing 110, and the diffusion plate 130 is disposed in the lamp housing 110 and located above the CCFLs 120.

In the conventional art, the light beams provided by the CCFLs 120 are uniformly diffused after passing through the diffusion plate 130, so as to form a more homogeneous planar light source. However, due to the poor light transmission rate of the diffusion plate 130, the overall brightness of the planar light source decreases. In order to solve the above problems, the conventional backlight module 100 usually further includes a plurality of optic films, for example, formed by a plurality of bottom diffusion sheets 140 or at least one bottom diffusion sheet 140 and at least one brightness enhancement film (BEF) 150. After passing through the bottom diffusion sheet 140 and the BEF 150, the light beams passing through the diffusion plate 130 have a converged diffusion angle, and thus, the brightness of the planar light source provided by the conventional backlight module 100 is improved after applying the plurality of optic films.

However, surfaces of the mentioned optic films (including the diffusion plate 130, bottom diffusion sheet 140, and BEF 150) must be processed by a microstructure process and an electrostatic process, such that the conventional backlight module 100 has a higher manufacturing cost. Furthermore, in order to prevent the optic films from being scratched during the assembly, the process of assembling the optic films with the lamp housing 110 is quite troublesome. Besides, since the optic films are relatively thinner, a droop phenomenon of the optic films easily occurs due to an insufficient support, and a waving phenomenon easily occurs due to being heated, and as a result, the planar light source provided by the conventional backlight module 100 has a non-homogeneous brightness.

### SUMMARY OF THE INVENTION

The present invention is directed to provide a high brightness diffusion plate, which is adapted for reducing the number of optic films, and further reducing the probability of scratching the optic films when being assembled inside a backlight module.

Other and advantages of the present invention can be further understood from the technical features disclosed by the present invention.

To achieve one, some or all of the above-mentioned advantages, one embodiment of the present invention provides a high brightness diffusion plate for homogenizing light beams provided by at least one light source of a backlight module to a display panel, the high brightness diffusion plate includes a diffusion layer, a transmittance layer and a plurality of connecters. The transmittance layer is disposed above the diffusion layer, and the connecters are respectively connected between the diffusion layer and the transmittance layer.

The high brightness diffusion plate of the present invention not only reduces the number of the optic films, but also is easily assembled inside the lamp housing. Meanwhile, due to the enhanced strength of the high brightness diffusion plate of the present invention, a waving phenomenon does not easily occur.

Other features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic structural view of a conventional backlight module.

FIG. 2 is a schematic structural view of a flat panel display device according to an embodiment of the present invention.

FIG. 3 is a partially-amplified schematic structural view of the high brightness diffusion plate in FIG. 2.

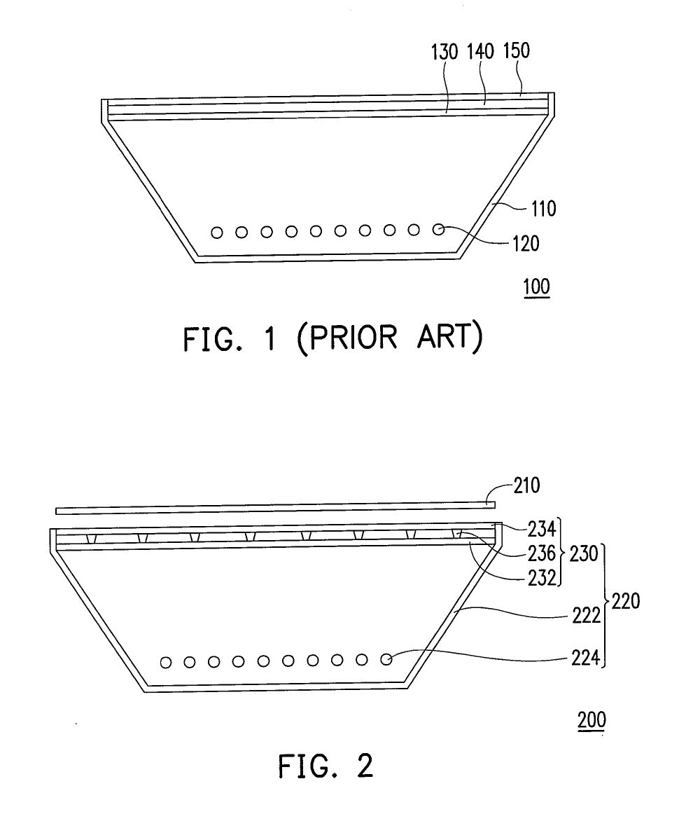

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

Referring to FIG. 2, a flat panel display device 200 according to an embodiment of the present invention includes a display panel 210 and a backlight module 220, and the backlight module 220 is used for providing a light source to the display panel 210. The backlight module 220 includes a lamp housing 222, a plurality of lamps 224, and a high brightness diffusion plate 230. The lamps 224 and the high brightness diffusion plate 230 are disposed within the lamp housing 222. The lamps 224 are, for example, arranged in the lamp housing 222 in parallel and spaced apart by an appropriate spacing, so as to provide the light beams to the display panel 210, and the high brightness diffusion plate 230 is disposed above the lamps 224 and close to the display panel 210, so as to homogenize the light beams provided by the lamps 224.

In this embodiment, the display panel 210 is, for example, a liquid crystal display (LCD) panel, the backlight module 220 is, for example, a direct type backlight module, and the lamps 224 are, for example, cold cathode fluorescence lamps (CCFL). However, the present invention is not limited to this embodiment. For example, the high brightness diffusion plate 230 of the present invention is also applied in other display panels demanding a backlight source, and is also disposed in other backlight modules such as a side type backlight module. Furthermore, the present invention also uses other light sources, including point light sources such as light emitting diodes (LED) or planar light sources such as flat lamp plates as the lamps 224 of the backlight module 220.

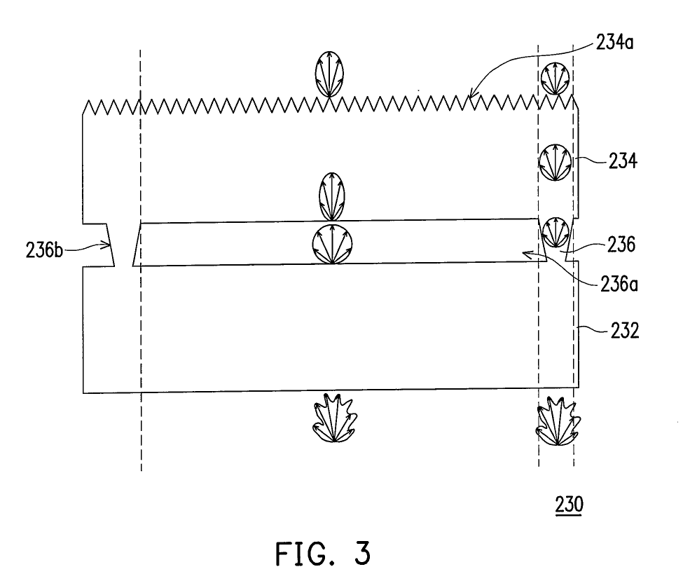

FIG. 3 is a partially-amplified schematic structural view of a high brightness diffusion plate in FIG. 2. Referring to FIGS. 2 and 3, the high brightness diffusion plate 230 includes a diffusion layer 232, a transmittance layer 234, and a plurality of connecters 236. The transmittance layer 234 is disposed above the diffusion layer 232, and the connecters 236 are connected between the diffusion layer 232 and the transmittance layer 234. The connecters 236 are connected between the diffusion layer 232 and the transmittance layer 234 by means of, for example, a bonding technique or a heat sealing technique.

In the high brightness diffusion plate 230 of the present invention, the connecters 236 are used to bond the diffusion layer 232 and the transmittance layer 234, so as to form an integrated structure, and thus, the high brightness diffusion plate 230 not only is easily assembled inside the backlight module 220, but also further alleviates the problem that the yield decreases due to being scratched or being covered by dusts during the assembly. Furthermore, the structure of the high brightness diffusion plate 230 of the present invention has an enhanced strength, and thus, not only a droop phenomenon caused by the gravitation in the place having an insufficient support does not easily occur, but also a waving phenomenon caused by the heat does not easily occur. Therefore, the present invention also provides a more homogeneous planar light source for the display panel 210 after the light beams pass through the backlight module 220. The connecters 236 include, for example, at least one of bumps and ribs. Besides the shape as shown in FIG. 3, the connecters 236 are also bumps or ribs having a spherical shape, a cubic cylindrical shape, a cylindrical shape, or another shape.

Furthermore, the light beams provided by the lamps 224 are projected onto the display panel 210 through two transmission paths. In the first transmission path, the light beams are incident into a gap 236a between the diffusion layer 232 and the transmittance layer 234 after passing through the diffusion layer 232, and then projected onto the display panel 210 after passing through the transmittance layer 234. In the second transmission path, the light beams are projected onto the display panel 210 after sequentially passing through the diffusion layer 232, the connecters 236, and the transmittance layer 234.

In an embodiment, a plurality of diffusion particles (not shown) are distributed in the diffusion layer 232 for diffusing the light beams of the light source incident into the diffusion layer 232. Once the light beams provided by the lamps 224 are incident into the diffusion layer 232, the refraction or reflection phenomenon occurs due to the diffusion particles, so that the transmission path of the light beams is diffused, and thus, the light beams are more homogeneous after passing through the diffusion layer 232. Meanwhile, the light beams present a light shape with a lambertian feature as shown in FIG. 3.

Then, in the first transmission path, after passing through the diffusion layer 232, the light beams pass through the gap 236a and are incident into the transmittance layer 234. Meanwhile, since the light beams travel from the air medium (having a lower refractive index) to the transmittance layer 234 (having a higher refractive index), after the light beams are incident into the transmittance layer 234, the light shape is converged, so that the brightness of the light beams is improved. Then, the light beams are projected onto the display panel 210 after passing through the transmittance layer 234. When the light beams travel from a light-emitting surface 234a of the transmittance layer 234 (having a higher refractive index) to the air medium (having a lower refractive index), the light shape is diverged, so that the brightness of the light beams is reduced. Therefore, in order to maintain the brightness of the light beams emitted from the light-emitting surface 234a, the light-emitting surface 234a is processed into a surface having a microstructure, so as to change the refractive directions of the light beams after passing through the light-emitting surface 234a, and thus, the light shapes of the light beams before and after passing through the light-emitting surface 234a are substantially the same.

In this embodiment, the light-emitting surface 234a has a microstructure of a saw tooth shape. However, in other embodiments, the light-emitting surface 234a also has a microstructure selected from a hill shape, a concave shape, a pyramid shape, a conical shape, a spherical shape, a polygon shape, and a combination thereof. Furthermore, the material of the transmittance layer 234 is, for example, polycarbonate (PC), polyethylene terephthalate (PET), polymeric methyl methacrylate (PMMA), or another material with a preferred light transmittance.

In the second transmission path, when the light beams are incident into the connecters 236 after passing through the diffusion layer 232, a part of light beams are directly incident into the transmittance layer 234 after passing through the connecters 236, and another part of light beams are projected to a side surface 236b of the connecters 236. Meanwhile, the part of light beams projected to the side surface 236b are totally reflected due to a large incident angle, and then, incident on the transmittance layer 234 after passing through the connecters 236. Therefore, although the transmission paths of a part of light beams are slightly converged due to the total reflection, most of the light beams are incident into the transmittance layer 234 and still maintain the light shape with the lambertian feature. The circumstance that the light beams are projected onto the display panel 210 after passing through the transmittance layer 234 is substantially the same as that in the first transmission path, thus the detailed description thereof is omitted.

Briefly, the light beams present the light shape with the lambertian feature after passing through the diffusion layer 232, so as to have a higher homogeneity. Then, the light beams projected onto the display panel 210 via the first transmission path have a slightly converged light shape due to passing through the mediums having different refractive indexes, so that the brightness of the light beams is improved. The light beams projected onto the display panel 210 via the second transmission path maintain the light shape with the lambertian feature, so as to maintain the original homogeneity.

In order to facilitate the assembly of the high brightness diffusion plate 230, the diffusion layer 232 and the connecters 236 is formed integrally. In other words, while the surface treating of the diffusion layer 232, a microstructure process is also performed on the surface, so as to make the connecters 236 become part of the microstructures on the surface of the diffusion layer 232. Therefore, the high brightness diffusion plate 230 is assembled as long as the transmittance layer 234 and the connecters 236 are connected.

Moreover, the transmittance layer 234 and the connecters 236 is also formed integrally. In other words, while the surface treating of the transmittance layer 234, a microstructure process is also performed on the light-emitting surface 234a of the transmittance layer 234 and the surface opposite to the light-emitting surface 234a, so as to make the connecters 236 become part of the microstructures on the surface of the transmittance layer 234. Meanwhile, only a surface treatment is needed for the diffusion layer 232, such that the process is simple. Likewise, the high brightness diffusion plate 230 is assembled as long as the diffusion layer 234 and the connecters 236 are connected.

Based on the above, the high brightness diffusion plate according to the embodiments of the present invention has one or a part of or all of the following advantages:

1. It is easy to assemble inside the backlight module.

2. The problem that the yield decreases due to being scratched or being covered by dusts during the assembly is alleviated.

3. The high brightness diffusion plate has an enhanced strength, and thus, a waving phenomenon does not easily occur, so as to provide a more homogeneous planar light source to the display panel.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A high brightness diffusion plate adapted for homogenizing light beams provided by at least one light source of a backlight module to a display panel, comprising:
a diffusion layer;
a transmittance layer, disposed above the diffusion layer; and
a plurality of connecters, connected between the diffusion layer and the transmittance layer.

2. The high brightness diffusion plate as claimed in claim 1, wherein the backlight module further comprises a plurality of lamps for providing the light source, a plurality of diffusion particles are distributed in the diffusion layer for diffusing light beams of the light source incident into the diffusion layer.

3. The high brightness diffusion plate as claimed in claim 2, wherein after passing through the diffusion layer, the light beams are adapted for being incident into the transmittance layer and passing through a light-emitting surface of the transmittance layer to be projected onto the display panel, and the shapes of the light beams before and after passing through the light-emitting surface are substantially the same.

4. The high brightness diffusion plate as claimed in claim 3, wherein the light-emitting surface has a microstructure selected from a hill shape, a concave shape, a pyramid shape, a conical shape, a spherical shape, a polygon shape, a saw tooth shape and a combination thereof.

5. The high brightness diffusion plate as claimed in claim 1, wherein the material of the transmittance layer comprises polyethylene terephthalate, polycarbonate, or polymeric methyl methacrylate.

6. The high brightness diffusion plate as claimed in claim 1, wherein the diffusion layer and the connecters are formed integrally.

7. The high brightness diffusion plate as claimed in claim 1, wherein the transmittance layer and the connecters are formed integrally.

8. The high brightness diffusion plate as claimed in claim 1, wherein the process of connecting the connecters between the diffusion layer and the transmittance layer comprises a bonding technique or a heat sealing technique.

9. The high brightness diffusion plate as claimed in claim 1, wherein the connecters comprise bumps or ribs.

10. The high brightness diffusion plate as claimed in claim 1, wherein the high brightness diffusion plate is used in a direct type backlight module.
